(19) United States
(12) Patent Application Publication
(10) Pub. No.: US 2024/0039014 A1
(43) Pub. Date: Feb. 1, 2024

(54) METHOD FOR SECURING A GASKET ON A BIPOLAR PLATE

(71) Applicants: ROBERT BOSCH GMBH, Stutigart-Feuerbach (DE); POWERCELL SWEDEN AB, Gothenburg (SE); GREENERITY GMBH, Alzenau (DE)

(72) Inventors: CHRISTOPH HALUSCHKA, Strullendorf (DE); EBERHARD MAIER, Koengen (DE); ALI RIZA YILDIRIM, Kirchheim A.N. (DE); MARTIN GERLACH, Strullendorf (DE); ANTON RINGEL, Bamberg (DE); ANDREAS RINGK, Bamberg (DE); FLORIAN ALEXANDER KNORR, Stuttgart (DE); AUDE MULLER, Stuttgart (DE); JENNY ANDERSSON, Goteborg (SE); MATTIAS HOLMBERG, Goteborg (SE); STEFAN MUNTHE, Vastra Frolunda (SE); STEFAN ANDERSCH, Goppingen (DE); HOLGER DZIALLAS, GroBkrotzenburg (DE); JENS-PETER SUCHSLAND, Alzenau (DE)

(21) Appl. No.: 18/268,071

(22) PCT Filed: Dec. 17, 2021
(86) PCT No.: PCT/EP2021/086560

§ 371 Date: Jun. 16, 2023

(30) Foreign Application Priority Data
Dec. 17, 2020 (DE) 10 2020 133 959.3

(51) Int. Cl. H01M 8/0286; H01M 8/0276

(52) U.S. Cl. CPC H01M 8/0286; H01M 8/0276

(57) ABSTRACT

The invention relates to a method of attaching a gasket (4) to a bipolar plate (12). The method comprises the steps of applying and aligning a first gasket foil (4a) to a second gasket foil (4b) having connection recesses (8), connecting the first gasket foil (4a) to the second gasket foil (4b), so that the gasket (4) is formed, placing the gasket (4) on the bipolar plate (12) so that the second gasket film (4b) with the bonding recesses (8) abuts the bipolar plate (12) and performing an embossing step in which an embossing force is applied with an embossing tool (20) in the region of the connecting recesses (8) so that an embossed adhesive point (24) is formed and the first gasket foil (4a) is bonded to the bipolar plate (12) via an adhesive means (16) arranged in the connecting recess (8) on the first gasket foil (4a).

The present invention relates to a method of attaching a gasket to a bipolar plate and to a fuel cell manufactured according to such method.

### PRIOR ART

Fuel cells are electrochemical energy converters in which, for example, hydrogen and oxygen are converted into water, electrical energy and heat. Fuel cells or fuel cell stacks are made up of multi-part cells which have membrane electrode units and bipolar plates arranged alternately on top of each other. The bipolar plates are used to supply the electrodes with reactants and to cool the fuel cell stack. For this purpose, the bipolar plates have a distributor structure that guides reactant-containing fluids along the electrodes. In addition, the distributor structures serve to guide a cooling fluid along the further distributor structures. These distributor structures are designed as channels through which the different fluids can be conducted.

DE 10 2005 058 370 A1 describes a fuel cell which has two bipolar plates, a membrane electrode unit being arranged between the bipolar plates and a gas diffusion layer being arranged between the membrane electrode unit and the bipolar plates. The membrane electrode unit is arranged on a support frame. An ultrasonic welded joint is formed between the membrane electrode unit and the support frame, via which the membrane electrode unit is connected to the support frame.

It is also known from the prior art that the carrier frame is directly connected to the bipolar plate via an ultrasonic welded joint. Likewise, a welded joint produced by means of a laser can be used instead of the ultrasonic welded joint. Although these methods have the advantage that no additional material is required, a rough surface is nevertheless necessary.

The object of the present invention is to provide a method of attaching a gasket to a bipolar plate in which the gasket can be attached to the bipolar plate in a simple and economical manner with little additional material.

To solve the problem, the method for attaching a gasket with a bipolar plate with the features of claim 1, as well as a fuel cell which is manufactured according to such a method, are given. Advantageous further embodiments of the invention are to be taken from the respective subclaims.

### DISCLOSURE OF THE INVENTION

A method is proposed for attaching a gasket to a bipolar plate, comprising the steps of applying and aligning a first gasket foil to a second gasket foil having connection recesses, connecting the first gasket foil to the second gasket foil so that the gasket is formed, placing the gasket on the bipolar plate so that the second gasket foil with the connection recesses abuts the bipolar plate. In a further process step, an embossing step is carried out in which an embossing force is applied with an embossing tool in the region of the connection recesses so that an embossed adhesive point is formed and the first gasket foil is connected to the bipolar plate via an adhesive agent arranged in the connection recess on the first gasket foil.

A bonding recess within the meaning of the present invention is understood to be an opening through the second gasket foil which enables a bonding. A bonding point is understood to be the area where the first gasket foil is bonded to the bipolar plate. Through the embossing step, the gasket is connected to the bipolar plate only in the area of the connection recesses. This connection is achieved by means of a simple embossing step. In addition, an adhesive only has to be provided in the area of the connection recesses. As a result, little adhesive is thus required to secure the gasket to the bipolar plate. Accordingly, only little additional material is required. Moreover, such a process can thus be carried out simply and economically.

In a preferred embodiment of the invention, an adhesive is applied to at least the first gasket film prior to bonding the first gasket film to the second gasket film. The first and second gasket films are thus joined together via an adhesive bond. Adhesive means is further arranged in this region through the connection recess. The gasket is bonded to the bipolar plate via this adhesive. Thus, no additional step is required to apply the adhesive. Since this adhesive agent is applied to join the first and second gasket films, no additional material is required to join the gasket to the bipolar plate. Thus, such a process can be carried out easily and economically.

In a further preferred embodiment of the invention, the adhesive is a UV adhesive, so that the UV adhesive is cured by means of a UV source. Preferably, at least the first gasket film is transparent to UV light so that the adhesive can be cured using a UV source. This process step allows the gasket to be bonded to the bipolar plate at a specific point in time, so that position correction is still possible. In addition, curing via UV light enables simple and controlled attachment.

Preferably, the adhesive is a hot melt adhesive, so that the gasket films are bonded together by means of a laminating process. A hot melt adhesive is an adhesive that changes to an adhesive state when exposed to heat. By means of such a process step, it is possible to easily join the two gasket films together by heating. In the lamination process, the two gasket films are preferably joined at a temperature of 100-200° C. and a pressure of 0.5-5 MPa.

In an advantageous further development, the embossing force is applied to the first gasket foil. Alternatively, it is of course also possible to apply the embossing force to the bipolar plate. However, since the first gasket foil is more compliant than the bipolar plate, this makes it easier to establish a connection between the bipolar plate and the first gasket foil. It also prevents the distributor structure of the bipolar plate from being damaged. Preferably, an embossing force in the range of 0.5-5 MPa is applied.

Advantageously, the embossing step heats up the embossing tool so that a hot glue arranged in the bonding recess bonds with the bipolar plate. In this way, an adhesive bond between the bipolar plate and the first gasket film can be achieved simultaneously with the embossing step. The number of process steps is thus reduced. Preferably, the embossing tool is heated to a temperature of 100-200° C. Particularly preferably, the temperature is 130-170° C.

Preferably, the hot melt adhesive is the adhesive applied to bond the first gasket film to the second gasket film, so that no additional process step for applying the hot melt adhesive or additional hot melt adhesive is required either.

A fuel cell for a fuel cell stack is further proposed. The fuel cell has at least one bipolar plate and a gasket, in which the gasket comprises a first and second gasket foil, the second gasket foil having connection recesses and bearing against the bipolar plate, and the gasket being connected to the bipolar plate via embossed adhesive dots, which are formed in the region of the connection recesses, by means of adhesive arranged in the connection recesses. The fuel cell is preferably manufactured according to the aforementioned process. Such a fuel cell thereby exhibits essentially the advantages described with respect to the process. In particular, such fuel cells exhibit a higher efficiency due to the positionally accurate arrangement of gasket and bipolar plate.

In a further advantageous embodiment, the adhesive dots have a geometric shape in which an adhesive dot side of the geometric shape runs parallel to a transverse center axis of the bipolar plate and is aligned with this transverse center axis. In this context, the geometric shape is understood to be the two-dimensional geometric shape which results from a top view of the bipolar plate through the glue point. The glue point side is a side of the geometric shape that runs as a line. The transverse center axis is an axis which runs transversely to the bipolar plate and is arranged centrally thereof. In addition to the parallel arrangement, this glue dot side is arranged closer to the transverse center axis than the other sides of the glue dot.

A peel force directed in the longitudinal direction accordingly acts orthogonally on the entire glue dot side, so that the peel force is better distributed on this glue dot side. This significantly improves the durability of such a glue dot.

According to an expedient embodiment, the adhesive dots additionally have an adhesive dot side which runs parallel to a longitudinal center axis and is aligned with this longitudinal center axis. A longitudinal center axis runs corresponding to the transverse center axis, in the longitudinal direction of the bipolar plate and is arranged in its center. Since, in principle, a peeling force also occurs in the transverse direction, but this is lower than the peeling force in the longitudinal direction, the durability of an adhesive dot with respect to a peeling force in the transverse direction is improved by an additional adhesive dot side aligned parallel to the longitudinal center axis. This adhesive dot side is aligned with a center in the transverse direction of the bipolar plate.

Furthermore, a fuel cell stack is proposed which has several fuel cells. Such a fuel cell stack has the advantages mentioned above.

Examples of embodiments of the invention are shown in the drawing and explained in more detail in the following description. It shows:

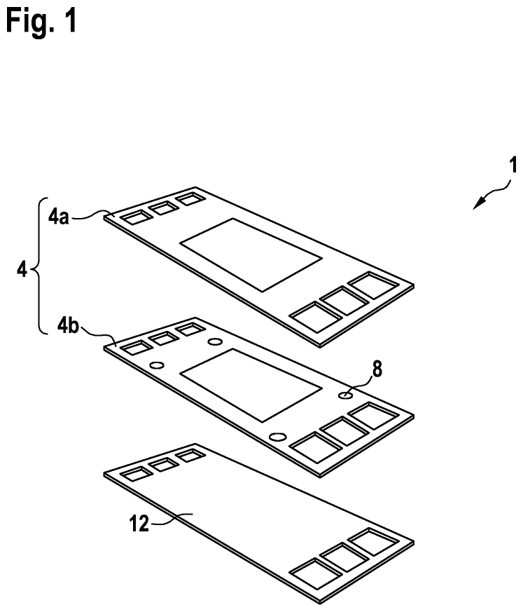

FIG. 1 Perspective view of the structure of a fuel cell according to the invention,

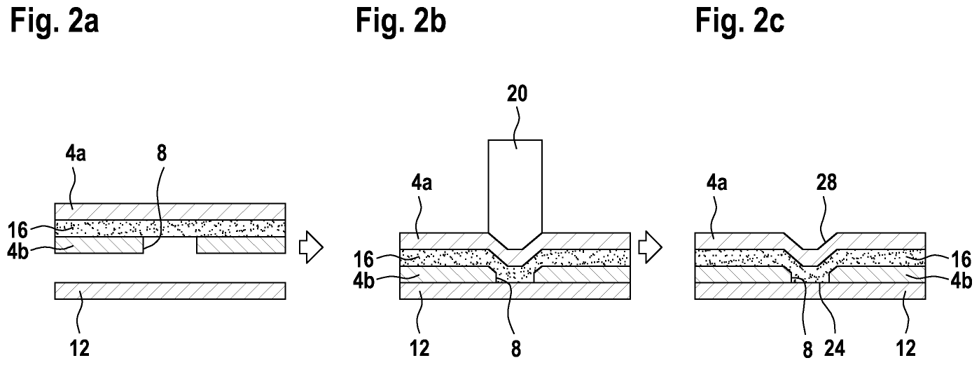

FIG. 2 Process steps for attaching the gasket to the bipolar plate, and

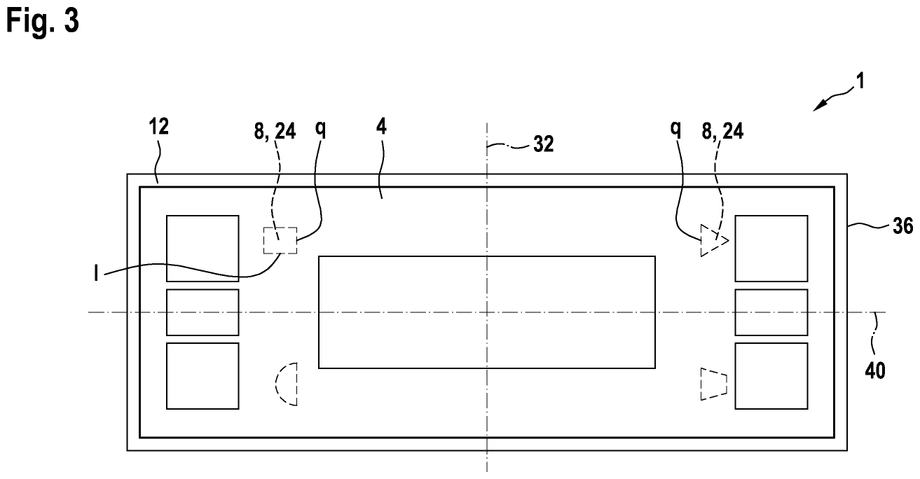

FIG. 3 Fuel cell with various embodiments of a glue dot.

FIG. 1 shows a perspective view of the structure of a fuel cell 1 according to the invention. The fuel cell 1 has at least a first gasket foil 4a and a second gasket foil 4b. The first gasket foil 4a and the second gasket foil 4b together form the gasket 4 of the fuel cell 1, which are stacked directly one on top of the other, as shown in the figure. In contrast to the first gasket foil 4a, the second gasket foil 4b has four connection recesses 8, which are arranged symmetrically on the second gasket foil 4b. In this embodiment example, these connection recesses 8 are designed as round holes. The fuel cell 1 additionally has a bipolar plate 12 on which the gasket 4 rests. In a known manner, the bipolar plate 12 has a distribution structure to guide the reactants along an electrode that is not shown.

FIG. 2 shows the process steps for attaching the gasket 4 to the bipolar plate 12. In this figure, a section through an area of a connection recess 8 is shown. The partial FIG. 2a. shows that an adhesive 16 is arranged between the first and second gasket foils 4a, 4b, via which both gasket foils 4a, 4b are joined together. In this embodiment, the adhesive 16 is a hot melt adhesive, via which both gasket foils 4a, 4b are joined together by means of a laminating process. Due to the bonding recess 8, no bonding of both gasket films 4a, 4b occurs in this area. Subfigure 2a shows the step before the gasket 4 is placed on the bipolar plate 12.

In subfigure 2b, the step in which an embossing step is performed by means of an embossing tool 20 is shown. In this step, the second gasket film 4b is in direct contact with the bipolar plate 12. The embossing tool 20 is positioned in the area of the connection recess 8 and applies an embossing force to the first gasket foil 4a. As a result, the adhesive 16 disposed on the first gasket film 4a is brought into contact with the bipolar plate 12. In this embodiment, the embossing tool 20 is heated so that the first gasket film 4a bonds to the bipolar plate 12 via the adhesive 16 formed as a hot melt adhesive.

The embossing step forms an embossed bonding point 24, which is essentially determined by the shape of the connection recess 8 and the shape of the embossing tool 20. Subfigure 2c shows the corresponding part of the fuel cell 1 after the embossing tool 20 has been removed. Here, it can be seen that a depression 28 has been formed in the first gasket foil 4a by the embossing tool 20. This indentation 28 extends into the connection recess 8 of the second gasket foil 4b. This further improves the mechanical connection between the two gasket foils 4a, 4b.

FIG. 3 shows a top view of a fuel cell 1 manufactured in this way. In this figure, apart from the round connection recesses 8 shown in FIG. 1, four further examples of embodiments for connection recesses 8 are shown with dashed lines. The connection recesses 8 produced in this way create corresponding geometric shapes of adhesive points 24.

The glue dot 24 shown as a triangle in the upper right corner has a glue dot side q which is formed parallel to a transverse center axis 32 of the fuel cell 1. In addition, this adhesive dot side q faces the transverse central axis 32, thereby applying a peeling force directed longitudinally toward edges 36 of the fuel cell 1 to the adhesive dot side q so as to improve the durability of the adhesive dot 24. The right and left lower bonding point 24 show further possible geometric formations which also exhibit these advantages.

In the upper left corner, an adhesive point 24 formed as a rectangle is shown. In addition to the aforementioned glue dot side q, this has a further glue dot side l, which is arranged parallel to a longitudinal center axis 40 and additionally faces the latter. This additionally improves the durability of the glue dot 24 with respect to a peeling force acting in the transverse direction.

### REFERENCE SIGNS

1 fuel cell
4 gasket
4a first gasket foil
4b second gasket foil
8 connection recess
12 bipolar plate
16 adhesives
20 embossing tool
24 adhesive point
28 refinement
32 transverse center axis
36 edge
40 longitudinal center axis
q adhesive dot side
l adhesive dot side

1. A method of securing a gasket with a bipolar plate comprising the steps of:
application and alignment of a first gasket foil on a second gasket foil having connecting recesses,
bonding the first gasket sheet to the second gasket sheet so that the gasket is formed,
placing the gasket on the bipolar plate so that the second gasket foil rests against the bipolar plate with the connection recesses,
performing an embossing step in which an embossing force is applied with an embossing tool in the region of the bonding recesses so that an embossed adhesive dot is formed and the first gasket sheet is bonded to the bipolar plate via an adhesive disposed in the bonding recess on the first gasket sheet.

2. The method of claim 1, characterized in that an adhesive is applied to at least the first gasket sheet prior to joining the first gasket sheet to the second gasket sheet.

3. The method according to claim 1, characterized in that the adhesive is a UV adhesive, so that the UV adhesive is cured by means of a UV source.

4. The method according to claim 2, characterized in that the adhesive is a hot glue, so that the gasket films are joined together by means of a laminating process.

5. The method according to claim 1, characterized in that the embossing force is applied to the first gasket foil.

6. The method according to claim 1, characterized in that with the embossing step, the embossing tool is heated so that a hot glue disposed in the bonding recess bonds to the bipolar plate.

7. A fuel cell for a fuel cell stack, the fuel cell having at least one bipolar plate and a gasket, in which the gasket comprises a first and a second gasket foil, the second gasket foil having connecting recesses and bearing against the bipolar plate and the gasket is bonded to the bipolar plate via embossed adhesive dots formed in the region of the bonding recesses by means of adhesive disposed in the bonding recesses.

8. The fuel cell according to claim 7, characterized in that the adhesive dots have a geometric shape in which an adhesive dot side of the geometric shape runs parallel to a transverse center axis of the bipolar plate and is aligned with this transverse center axis.

9. The fuel cell according to claim 8, characterized in that the adhesive dots additionally have an adhesive dot side that runs parallel to a longitudinal center axis and is aligned with this longitudinal center axis.

10. A fuel cell stack comprising a plurality of fuel cells according to claim 7.

11. A fuel cell stack comprising a plurality of fuel cells according to claim 8.

12. A fuel cell stack comprising a plurality of fuel cells according to claim 9.
